(19) United States
(12) Patent Application Publication
(10) Pub. No.: US 2018/0239051 A1
(43) Pub. Date: Aug. 23, 2018

(54) SCINTILLATING GAMMA RAY SPECROMETER AND ITS USE IN MUD LOGGING SYSTEM

(71) Applicant: SHELL OIL COMPANY, Houston, TX (US)

(72) Inventors: Matthias APPEL, Houston, TX (US); Anton NIKITIN, Houston, TX (US); Robert Adam WALSH, Katy, TX (US); Ronny HOFMANN, Houston, TX (US)

(21) Appl. No.: 15/897,674

(22) Filed: Feb. 15, 2018

Related U.S. Application Data
(60) Provisional application No. 62/461,063, filed on Feb. 20, 2017.

(51) Int. Cl. G01V 5/06; G01V 3/32; G01V 11/00

(52) U.S. Cl. CPC G01V 5/06; G01V 11/002; G01V 3/32

(57) ABSTRACT

A gamma ray scintillation spectrometer is disclosed in which an inorganic scintillation crystal has a channel extending therethrough for receiving a sample into, and disposing a sample out of, the scintillation crystal. The spectrometer further includes a photomultiplier tube optically coupled to the scintillation crystal to detect photons generated by the scintillation crystal. A system and a method for using the gamma ray scintillation spectrometer are also provided.

### TECHNICAL FIELD OF THE INVENTION

The present disclosure relates generally to a scintillating gamma ray spectrometer useful in systems and methods for well logging in parallel with drilling oil and gas wells.

### BACKGROUND OF THE INVENTION

Wellbore logging generally refers to the process of mapping out the properties of a formation through which a wellbore extends. Decisions about drilling operations may be made based on the information derived from wellbore logging. Typically, a wellbore may be logged by a wireline logging process or a logging while drilling (LWD) process. In a wireline logging process, after a wellbore is drilled in a formation a sensor probe is dropped into the wellbore and properties of the formation are measured while pulling the probe back out of the wellbore using a long cable or wireline. In a LWD process, the wellbore properties are measured and recorded as the wellbore is drilled using sensors located in the drill string far away from the drill bit. A measurement while drilling (MWD) system may be used in an LWD process to provide further real-time or near-real-time information regarding drilling-specific measurements, including drilling bit torque, rotation rate, drill telemetry and other parameters.

During oil and gas well drilling operations, a weighted fluid or mud is typically introduced into a borehole created by the drill through the interior of the drill string, exiting the drill string at the bit. This mud may serve several purposes, one of which is to flush drill cuttings from the drilling area and back to the surface. During a drilling operation, drill cuttings may be used to provide information about properties of the formation, particularly the formation's composition, density, porosity, and other petrophysical properties.

The drill cuttings may provide the earliest available information about the characteristics of the formation being drilled. Cuttings take some time to travel from the bottom of the well being drilled to the surface depending on the mudflow conditions within the well, typically taking around 10 minutes to travel 1,000 feet. Despite this time lag, cuttings often arrive to the surface before sensors of an LWD/MWD system reach their depth of origin. As a result the cuttings may be analyzed to provide the first analytical information about the formation penetrated by the drill bit. The analysis of the cuttings may be performed as a part of a mud logging operation.

Analysis of the natural gamma ray radiation of the cuttings provides information about the type of rock that forms the cuttings. Such information may prove useful in drilling decisions. Potassium, thorium, and uranium are the three natural sources of gamma ray radiation present in the earth. Shales can be distinguished from other types of rock due to the relatively high levels of these gamma ray radiating elements present in shale. Further information about the formation can be determined by NMR analysis of the cuttings, which may be used to determine the porosity of the formation as well as the water and hydrocarbon content within the pores of the cuttings, and by neutron induced gamma ray spectroscopy, which can be used to determine the concentration of carbon, hydrogen, oxygen, calcium, silicon, aluminum, iron, magnesium, sulfur, chlorine and other elements within the cuttings.

In order to obtain information about the properties of the formation from cuttings on a “real-time” basis that may be used for drilling decision making, either on a first-information basis or in conjunction with LWD/MWD logs, samples of the cuttings may be sequentially analyzed for natural gamma spectra, NMR, and neutron induced gamma spectra. US Patent Application Publication No. 2008/0202811 provides an apparatus and method for analyzing drilling cuttings on a continuous or semi-continuous flow basis. Samples of the drilling cuttings are prepared by removing them from the drilling mud with a shaker. The cuttings samples are then fed into a hollow tube having an auger extending through the tube and are moved through the tube by rotating the auger. A natural gamma ray sensor, a natural beta ray sensor, a sonic sensor, and a neutron induced gamma ray sensor are disposed on the exterior of the tube and provide analytical measurements on the cutting samples as they pass through the tube. Alternatively, the auger is hollow and the sensors are disposed at fixed locations on the interior of the hollow auger to analyze the cuttings samples as they pass through the tube.

A problem with analyzing the natural gamma ray spectra of drilling cuttings on a continuous or semi-continuous flow basis to provide real time analysis as conducted in the art is that the signal is very weak and may be insufficient to provide the required information. In particular, disposition of the drillings cuttings apart from the scintillation crystal of the natural gamma ray detector reduces detection of an already weak signal by limiting the area of the scintillation crystal of the detector exposed to the gamma ray source.

### SUMMARY OF THE INVENTION

In one aspect, the present invention is gamma ray scintillation spectrometer, comprising:
an inorganic scintillation crystal, the scintillation crystal having a length along an axis, wherein a channel extends through the scintillation crystal and wherein the channel has a length along the axis that is at least ⅖, or at least ½, the length of the scintillation crystal along the axis; and
a photomultiplier tube optically coupled to the scintillation crystal in a configuration to detect photons emitted by the scintillation crystal.

In another aspect, the present invention is directed to a system for analyzing samples for gamma ray emissions, comprising: a gamma ray scintillation spectrometer comprising an inorganic scintillation crystal and a photomultiplier tube optically coupled to the scintillation crystal in a configuration to detect photons emitted by the scintillation crystal in response to a sample, wherein a channel extends through the scintillation crystal, the channel being configured to receive a sample into the scintillation crystal and to dispose a sample out of the scintillation crystal.

In a further aspect, the present invention is directed to a method for analyzing drill cuttings in the process of oil and gas well drilling operations, comprising:
preparing a drill cuttings sample from drill cuttings recovered from an oil and gas well during drilling operations;
providing a gamma ray scintillation spectrometer comprised of an inorganic scintillation crystal and a photomultiplier tube optically coupled to the scintillation crystal in a configuration to detect photons emitted by the scintillation crystal in response to the sample, wherein a channel extends through the scintillation crystal, the channel being configured to receive the sample into the scintillation crystal and to dispose the sample out of the scintillation crystal;
introducing the sample into the channel; and
measuring a gamma ray spectrum of the sample with the gamma ray scintillation spectrometer.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is an exploded view of a gamma ray scintillation spectrometer of the present invention with a sample located in the spectrometer.

FIG. 2 is a cross-sectional, non-exploded, view of the gamma ray scintillation spectrometer of FIG. 1 taken along line 2 with a sample located in the spectrometer.

FIG. 3 is an exploded view of another embodiment of a gamma ray scintillation spectrometer of the present invention.

FIG. 4 is an exploded view of a yet another embodiment of a gamma ray scintillation spectrometer of the present invention

FIG. 5 is an exploded view of yet another embodiment of a gamma ray scintillation spectrometer of the present invention.

FIG. 6 is a depiction of a gamma ray scintillation spectrometer of the present invention with an ionization radiation shield disposed about the scintillation crystal of the spectrometer.

FIG. 7 is a schematic of the system to perform cuttings sample characterization according to an embodiment of the present invention.

FIG. 8 is a depiction of an embodiment of a neutron induced gamma ray spectrometer that may be used in an embodiment of the system of the present invention to analyze cuttings samples.

FIG. 9 is a schematic of a method to perform cuttings sample characterization according to an embodiment of present invention.

### DETAILED DESCRIPTION OF THE INVENTION

In one aspect, the present invention is directed to a gamma ray scintillation spectrometer that may be utilized to analyze samples for natural gamma ray emissions on a continuous or semi-continuous basis to provide real time analysis capability in which the spectrometer is quite sensitive to gamma rays and the detection signal provided by the spectrometer is strong. The gamma ray scintillation spectrometer is structured and arranged with a channel extending through a gamma ray detecting scintillation crystal, where the crystal has a length extending along an axis and the channel has a length along that axis that is at least ⅖, or at least ½, the length of the crystal along the axis. Samples may be passed through the channel on a continuous or semi-continuous basis for analysis of their natural gamma ray spectra, and a strong gamma ray response signal may be generated by the spectrometer for each sample since the sample is located within and is surrounded by the gamma ray detecting scintillating crystal. A system for automatically analyzing samples for natural gamma ray emissions is provided by the present invention which includes a gamma ray scintillation spectrometer comprising a gamma ray detecting scintillation crystal with a channel extending through the crystal. A method for analyzing samples for natural gamma ray emissions using such a system is also provided.

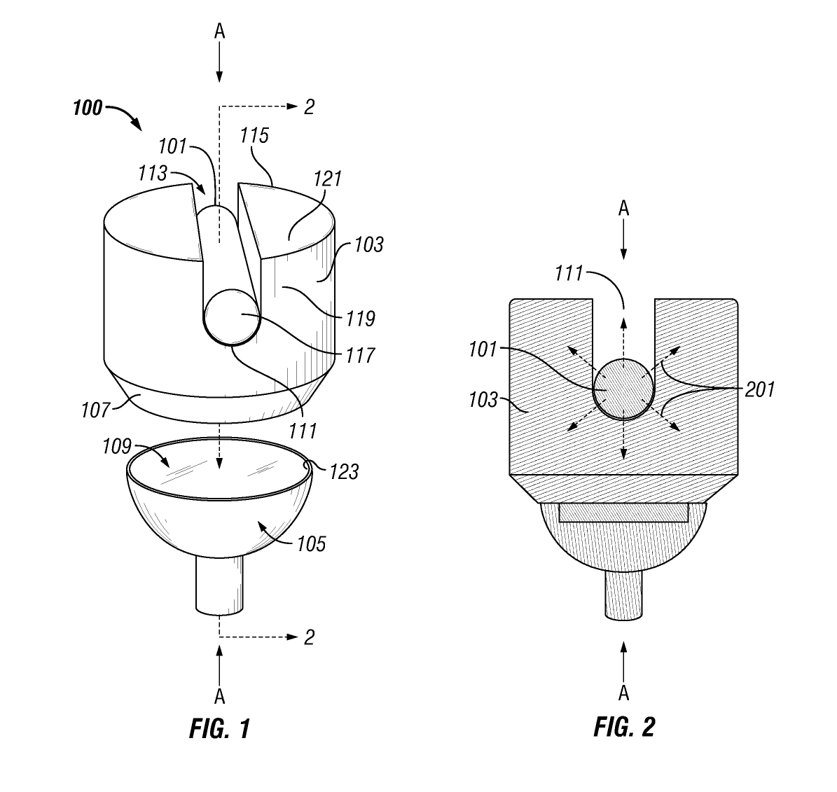

Referring now to FIG. 1, an embodiment of the gamma ray scintillation spectrometer 100 of the present invention is shown with a sample 101 disposed therein. The scintillation spectrometer is comprised of an inorganic scintillation crystal 103 and a photomultiplier tube 105. The scintillation crystal 103 and the photomultiplier tube 105 are optically coupled, where the photomultiplier tube is optically coupled with the scintillation crystal in a configuration to detect photons emitted by the scintillation crystal. In a preferred embodiment, the photomultiplier tube 105 may be structured and arranged to receive a portion 107 of the scintillation crystal 103 within a receiving section 109 of the photomultiplier tube, where the scintillation crystal and photomultiplier tube are physically joined by location of the portion 107 of the scintillation crystal in the receiving section 109 of the photomultiplier tube.

The scintillation crystal 103 is formed of a solid inorganic luminescent material that generates photons of light in response to contact with gamma rays. Such inorganic luminescent materials include sodium iodide (NaI), cesium iodide (CsI), and bismuth germante. Sodium iodide is a particularly preferred solid inorganic luminescent material for use in the scintillation spectrometer of the present invention since relatively large sodium iodide crystals may be formed easily. A large crystal is preferred for use in the scintillation spectrometer so that a relatively large channel may be formed therein in which a sample may be positioned to be substantially surrounded by the scintillation crystal.

The scintillation crystal material may include one or more activators to enhance emission of photons by the scintillation crystal material that are within a range of wavelengths that are detectable by the photomultiplier tube. Such activators may be present as impurities in the scintillation crystal material, and may be introduced to the crystal as a dopant. Thallium is a preferred activator for use in a sodium iodide or cesium iodide scintillation crystal utilized in the present invention, where a thallium doped sodium iodide crystal is a preferred inorganic scintillation crystal material for use in the gamma ray scintillation spectrometer of the present invention. Preparation of such activated scintillation crystal materials may be conducted in accordance with methods known in the art.

The scintillation crystal 103 may have any geometry suitable for having a channel 111 disposed therethrough of sufficient size to receive a sample therein and for detecting gamma rays from the sample when it is located in the channel As shown in FIG. 1, the scintillation crystal preferably has a cylindrical shape with a frusto-conically shaped end 107, where the frustum end of the crystal is shaped to fit within the receiving section 109 of the photomultiplier tube 105. The scintillation crystal may also have the shape of a cube, a cuboid or rectangular parallelepiped, a sphere, an ovoid, a pyramid, or a cone.

The gamma ray detecting scintillation crystal 103 has a channel 111 extending therethrough. The channel 111 has a first opening 113 in a face 115 of the scintillating crystal and has a second opening 117 in a face 119 opposite face 115 where the channel extends through the scintillation crystal from the first opening 113 to the second opening 117. A sample 101 may be introduced into the channel 111 through the first opening 113 and may be removed from the channel through the second opening 117. The channel 111 is structured and arranged so that a sample 101 may be located in the channel in a position substantially surrounded by the scintillating crystal to detect gamma rays emitted from the sample.

The channel may be created in the crystal by growing the crystal around an object designed to produce the channel in the crystal. Alternatively, the channel may be cut in a fully formed crystal.

Referring still to FIG. 1, the channel has a maximum length along an axis A, where the maximum length is at least ⅖, or at least ½, the length of the scintillating crystal along the same axis A. The axis along which the length of the channel and the length of the crystal are measured may be any axis that bisects the scintillation crystal. Preferably, however, the channel is disposed in the crystal so that a sample located in the channel is centered within the crystal. In a preferred embodiment, the length of the channel along the axis is substantially the same over the channel as the channel extends through the crystal. This enables a sample to easily be introduced and removed from the channel

Referring now to FIG. 2, the length of the channel 111 along axis A relative to the length of the scintillating crystal 103 along the same axis enables the scintillating spectrometer 100 to be quite sensitive and effective at producing a signal in response to gamma rays emitted by a sample 101 in the spectrometer. When the sample 101 is in the channel 111 within the scintillating crystal 103 it is substantially surrounded by the crystal. As a result, most gamma rays 201 emitted by the sample 101 are directed towards the crystal 103 so that the gamma rays may interact with the crystal to generate photons of light. Very few gamma rays emitted by the sample escape without contacting the crystal. The gamma ray scintillation spectrometer 100 of the present invention, therefore, provides a high detection efficiency of gamma rays from samples as they pass through the spectrometer.

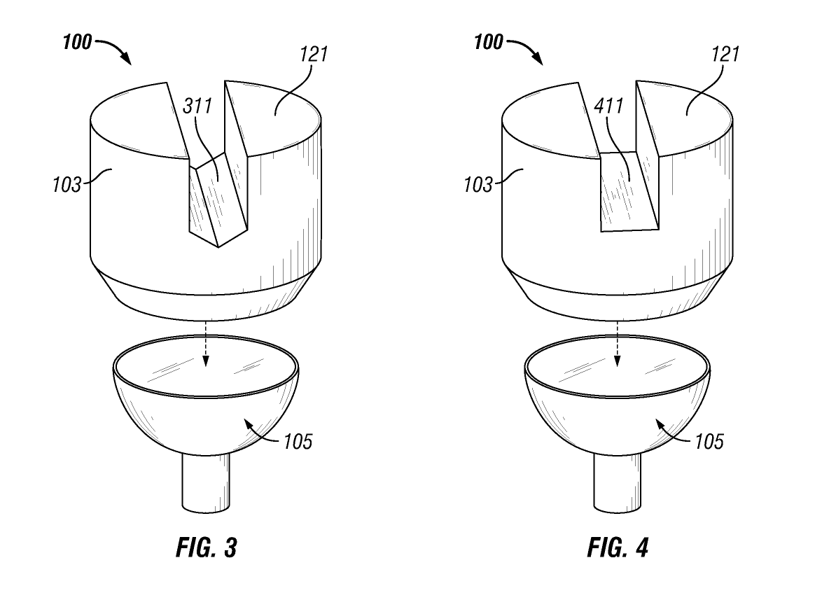

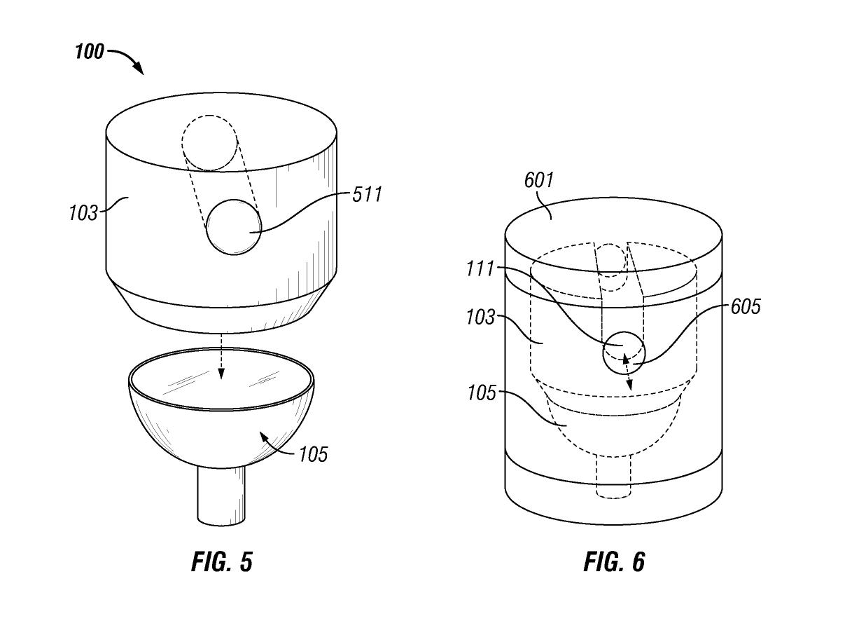

Referring now to FIGS. 1, 3, 4, and 5, the channel 111 extending through the scintillating crystal 103 may be selected to have different geometries. In Fig.1 the scintillating spectrometer 100 may have a scintillating crystal 103 with a channel 111 having a cross-sectional profile of a groove extending from an end 121 of the crystal to a semi-circular groove end. As shown in FIG. 3, the cross-sectional profile of the channel 311 may be that of a groove extending from an end 121 of the crystal to a triangular groove end; and in FIG. 4 the cross-sectional profile of the channel 411 may be that of a square notch extending from an end 121 of the crystal. As shown in FIG. 5, the channel 511 may have a circular cross-sectional profile extending as a borehole through the crystal 103. The geometry of the channel is not critical and may be selected from a variety of geometries provided that a sample may enter the channel at a first opening of the channel and leave the channel though a second opening of the channel

Referring back to FIG. 1, the photomultiplier tube 105 of the gamma ray scintillating spectrometer 100 may be any conventional photomultiplier tube. As noted above, the photomultiplier tube is optically coupled to the scintillating crystal, and may be physically coupled to the scintillating crystal by locating an end 107 of the crystal in a receiving portion 109 of the photomultiplier tube. Optical coupling grease, in an embodiment a silicon grease, may be applied at the contact interface between the end 107 of the crystal 103 and the receiving portion 109 of the photomultiplier tube to reduce the loss of scintillation photons by preventing reflection of the photons at the contact interface. The photomultiplier tube generates an electrical signal from detected photons of light emitted by the scintillating crystal that is proportional to the gamma ray energy absorbed in the scintillating crystal. The electrical signal produced by the photomultiplier tube may be used to generate a gamma ray spectrum for analysis.

In an embodiment, the photomultiplier tube has an optical window 123 located in the receiving portion 109 of the photomultiplier tube. The optical window 121 of the photomultiplier tube is optically aligned with the end 107 of the crystal physically located in the receiving portion 109 of the photomultiplier tube to permit photons generated by the scintillating crystal to enter the photomultiplier tube.

Referring now to FIG. 6, the coupled scintillation crystal 103 and photomultiplier tube 105 maybe placed inside of an ionization radiation shield 601. The ionization radiation shield 601 may absorb background radiation to minimize the background signal in the measured spectra. The ionization radiation shield may be formed of any material effective to inhibit gamma ray radiation contacting the scintillation crystal other than gamma ray radiation emitted by the sample within the scintillation crystal. In an embodiment, the ionization radiation shield is formed of lead.

One or more apertures 605 extend through the ionization shield 601. The one or more apertures 605 are structured and arranged to align with the channel 111 in the scintillation crystal 103 when the ionization shield 603 is located in position around the scintillation crystal to provide an opening continuously extending through the ionization radiation shield and the scintillation crystal. Samples may be provided into the channel 111 in the scintillation crystal and removed therefrom through the one or more apertures 605 in the ionization radiation shield.

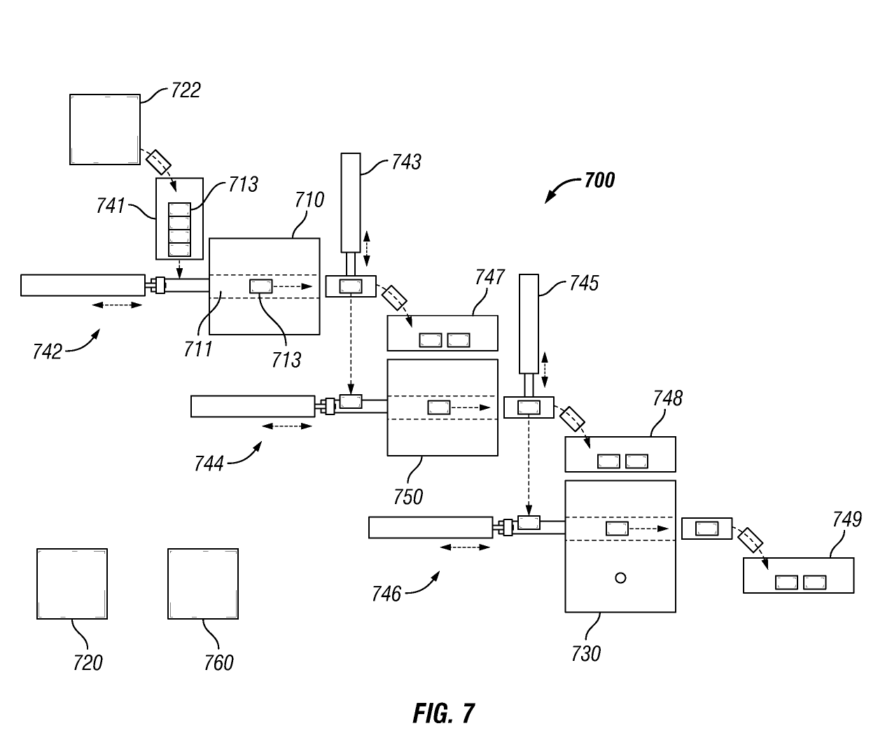

In another aspect, the present invention is a system for sequentially analyzing samples for gamma ray emissions. Referring now to FIG. 7, a system 700 that is an embodiment of the present invention is shown. The system 700 comprises a gamma ray scintillation spectrometer 710 comprising an inorganic scintillation crystal and a photomultiplier tube optically coupled to the scintillation crystal in a configuration to detect photons emitted by the scintillation crystal in response to a sample. A channel 711 extends through the scintillation crystal configured to receive a sample 713 into the scintillation crystal and to dispose the sample out of the crystal. The scintillation crystal has a length along an axis and the channel 711 has a length along the axis where the length of the channel along the axis may be at least ⅖, or at least ½, the length of the crystal along the axis. In an embodiment, the scintillation spectrometer 710 is a scintillation spectrometer in accordance with a gamma ray scintillation spectrometer as described above.

The system 700 may have a sample feeder 742, where the sample feeder is configured to feed a sample 713 into the channel of the scintillation spectrometer 710. The sample feeder 742 may be activated manually to feed a sample into the channel of the scintillation spectrometer or may be activated automatically in response to a controller 720, where the sample feeder may be operatively coupled to the controller for activation by the controller. The sample feeder 742 may be configured to move the sample through the scintillation spectrometer and to remove the sample from the spectrometer. For example, the sample feeder 742 may be a retractable piston that pushes a sample 713 into, through, and out of the channel in the scintillation spectrometer 710 in response to activation.

The controller 720 may be a device for controlling automated processes. The controller may be a computer or a computer network. In certain embodiments, the controller may comprise a display screen and an input panel to allow a worker to input control instructions to the controller 720.

The system may include a sample holder 741 structured and arranged for holding one or more samples 713. The sample holder 741 may be configured for manual or automatic activation, where the sample holder provides a sample to the sample feeder 742 upon activation. The sample holder may be operatively coupled to the controller 720 for activation by the controller, where the controller may coordinate activation of the sample holder and the sample feeder so the sample holder provides a sample to the sample feeder, then the sample feeder provides the sample to the scintillation spectrometer 710.

The system 700 may include a sample preparation unit 722. The sample preparation unit 722 may be operatively coupled to the sample holder 741, or alternatively to the sample feeder 742, to provide samples to the sample holder 741 or to the sample feeder 742 in the absence of a sample holder, or alternatively directly to the scintillation spectrometer 710 in the absence of a sample feeder and a sample holder. The sample preparation unit 722 may receive drilling mud containing drill cuttings from a well, either automatically or manually, and prepare samples therefrom. The sample preparation unit 722 may comprise a shaker, as known in the art, which separates drill cuttings from drilling mud by placing the drilling mud containing the drill cuttings over a mesh and shaking the mixture to separate the drill cuttings from the drilling mud. The sample preparation unit 722 may optionally wash the separated drill cuttings to remove drilling mud contamination. The sample preparation unit 722 may place the separated drill cuttings in a sample container. Optionally, after placing the drill cuttings in the sample container, the sample preparation unit 722 may fill the sample container with a hydrocarbon liquid used in the drilling mud to fill the void space in the sample container. The sample container may then be provided by the sample preparation unit 722, either automatically or manually, as a sample 713 to the sample holder 741 or the sample feeder 742, or to the scintillation detector 710. The sample preparation unit 722 may be operatively coupled to the controller 720 for activation by the controller, where the controller may coordinate activation of the sample preparation unit with the sample holder 741 or the sample feeder 742 or the scintillation detector 710 so samples prepared by the sample preparation unit are fed to the sample holder 741 or the sample feeder 742 or the scintillation detector 710.

In an embodiment, the system 700 may include a NMR relaxometer 750 to analyze fluids occupying the pores in the drill cuttings material of the sample 713. The NMR relaxometer may be any conventional NMR relaxometer configured to analyze a sample 713 as it passes through the NMR relaxometer. The NMR relaxometer 750 may be a low magnetic field NMR relaxometer.

The system 700 may include a NMR relaxometer sample selector 743 and a NMR relaxometer sample feeder 744. The NMR relaxometer sample selector 743 may be operatively coupled to the gamma ray scintillation spectrometer 710 to receive a sample from the spectrometer as the sample exits the spectrometer. The sample selector 743 may be structured and arranged to select between providing a sample to the sample feeder 744 for analysis by the NMR relaxometer or disposing of the sample to a sample collector 747. The NMR relaxometer sample feeder 744 may be configured to feed a sample into the NMR relaxometer 750. The NMR relaxometer sample selector 743 and the NMR relaxometer sample feeder 744 may be activated manually to feed a sample into the NMR relaxometer 750 or may be activated automatically in response to the controller 720, where both the sample selector 743 and the sample feeder 744 may be operatively coupled to the controller for activation by the controller. The NMR relaxometer sample feeder 744 may be configured to move the sample through the NMR relaxometer and to remove the sample from the NMR relaxometer. For example, the sample feeder 744 may be a retractable piston that pushes a sample 713 into, through, and out of the NMR relaxometer 750 in response to activation.

In an embodiment, the system 700 may include a neutron induced gamma ray spectrometer 730 (NIGS) to analyze the elemental composition of a sample. The NIGS 730 may be comprised of any conventional gamma ray spectrometer in combination with a neutron source. The gamma ray spectrometer of the NIGS 730 may be a conventional gamma ray scintillation detector. Preferably the gamma ray spectrometer of the NIGS 730 is a gamma ray scintillation detector as described above.

The neutron source of the NIGS 730 may be comprised of a pulsed neutron generator. In certain embodiments, the neutron source may comprise a deuterium-tritium (D-T) neutron generator capable of emitting neutrons with 14 MeV energy.

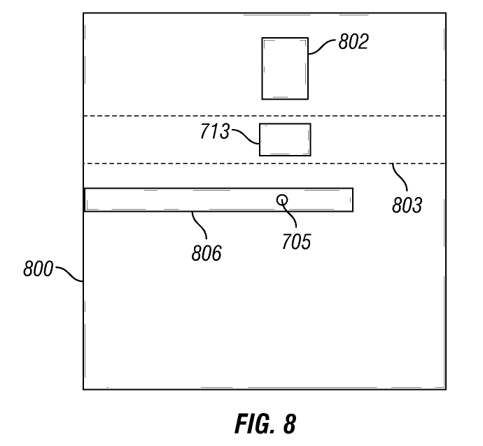

An embodiment of the NIGS is shown in FIG. 8. The NIGS 800 may be comprised of a pulsed neutron generator 705 for generating high energy neutrons, a neutron shield/thermalizer 806, a gamma ray detector 802, and a sample channel 803. A sample 713 may enter the NIGS in the sample channel 803. Neutrons from the neutron generator 705 contact the sample 103 and generate gamma ray emissions upon contacting the sample. The gamma ray detector detects the gamma ray emissions and produces a signal.

Referring back to FIG. 7, the system 700 may include a NIGS sample selector 745 and a NIGS sample feeder 746. The NIGS sample selector 745 may be operatively coupled to the NMR relaxometer 750 to receive a sample from the relaxometer as the sample exits the relaxometer. The NIGS sample selector 745 may be structured and arranged to select between providing a sample to the NIGS sample feeder 746 for analysis by the NIGS 730 or disposing of the sample to a sample collector 748. The NIGS sample feeder 746 may be configured to feed a sample into the NIGS 730. The NIGS sample selector 745 and the NIGS sample feeder 746 may be activated manually to feed a sample into the NIGS 730 or may be activated automatically in response to the controller 720, where both the NIGS sample selector 745 and the NIGS sample feeder 746 may be operatively coupled to the controller for activation by the controller. The NIGS sample feeder 746 may be configured to move the sample through the NIGS 730 and to remove the sample from the NIGS. For example, the NIGS sample feeder 746 may be a retractable piston that pushes a sample 713 into, through, and out of the NIGS 730 in response to activation.

The system 700 may also include a sample collector 749 for collecting samples after analysis by the gamma ray scintillation spectrometer 710, the NMR relaxometer 750, and the NIGS 730. The sample collector 749 may be operatively coupled to the NIGS 730 to receive samples exiting the NIGS.

The system 700 may further include an interpretation module 760. The interpretation module may be operatively coupled to the gamma ray scintillation spectrometer 710, to the NMR relaxometer 750, or to the NIGS 730, or to each or any of them, to receive data therefrom. The interpretation module 760 may be directly coupled to the gamma ray scintillation spectrometer 710, to the NMR relaxometer 750, or to the NIGS 730, or the interpretation module may be indirectly coupled thereto through the controller 720.

The interpretation module 760 may process the data received from the gamma ray scintillation spectrometer 710, the NMR relaxometer 750, and/or the NIGS 730 to provide petrophysical property information about the drill cutting samples. The interpretation module may comprise a database, processor, CPU, and/or any other computing device capable of receiving, processing, and/or storing data from the gamma ray scintillation detector, the NMR relaxometer, and/or the NIGS.

The interpretation module 760 may be structured and arranged to process information from the gamma ray scintillation spectrometer 710 to provide output data directed to the concentration of potassium, uranium, and/or thorium in the drill cutting sample. In certain embodiments, the interpretation module may be configured to provide the lithology of the drill cuttings from the potassium, uranium, and/or thorium concentration data.

The interpretation module 760 may be structured and arranged to process information from the NMR relaxometer 750 to determine a concentration of fluids present inside the drilling cutting of a sample. Based on data from the NMR relaxometer, the interpretation module may be configured to analyze the concentration of residual fluids present in the pores of the formation cuttings. In one embodiment this information can be used to quantify the relative degree of the interconnectivity of hydrocarbon wet porosity present in the formation. In another embodiment this information can be used to quantify the relative concentration of clay porosity.

The interpretation module 760 may be structured and arranged to process information from the NIGS 730 to determine the presence and/or concentration of carbon, hydrogen, oxygen, calcium, silicon, aluminum, iron, magnesium, sulfur, chlorine, and/or the presence or concentration of other elements in a drill cutting sample. The interpretation module may be configured to provide a mineralogy analysis of the composition of a drill cutting sample from the NIGS data, for example, providing an analysis as to whether the cuttings are comprised of quartz, calcite, dolomite, one or more clays, pyrite, or other minerals. The interpretation module may also be configured to determine the concentration of organic carbon from the NIGS data.

The formation properties provided by the interpretation module as discussed above may provide substantial information to assess the ability of a formation to produce hydrocarbons and/or to estimate the mechanical properties of the formation to determine frackability of the formation.

The system 700 includes the gamma ray scintillation spectrometer 710 and may include a NMR relaxometer 750 and/or a NIGS 730. The system may or may not include an NMR relaxometer and may or may not include a NIGS.

The order of the gamma ray scintillation spectrometer, NMR relaxometer, and NIGS in the system is not critical. The NIGS may be operatively coupled to the gamma ray scintillation spectrometer to receive a sample therefrom and the NMR relaxometer may be operatively coupled to the NIGS to receive a sample therefrom. The NMR relaxometer may be directly or indirectly coupled to the gamma ray scintillation spectrometer to receive a sample from the gamma ray scintillation spectrometer or to provide a sample to the spectrometer. The NIGS may be directly or indirectly coupled to the gamma ray scintillation spectrometer to receive a sample from the spectrometer or to provide a sample to the spectrometer. The NMR relaxometer may be directly or indirectly coupled to the NIGS to receive a sample from the NIGS or to provide a sample to the NIGS. The gamma ray scintillation spectrometer, NMR relaxometer, and/or NIGS may be arranged in any order in the system.

In a further aspect, the present invention is a method for analyzing drill cuttings from, and in the process of, oil and gas well drilling operations. The methods of the present invention may be useful to acquire composition and petrophysical property information in relation to a geological formation as a wellbore is drilled through the formation. As such, the methods of the present invention may be used as a well logging operation to generate formation lithology and/or mineralogy from analysis of drill cuttings from a wellbore during a drilling operation.

The method comprises the steps of preparing a drill cuttings sample from drill cuttings recovered from an oil or gas well during drilling operations and measuring a gamma ray spectrum of the sample with a gamma ray scintillation spectrometer. Initially, a drill cuttings sample is prepared from drill cuttings. A gamma ray scintillation spectrometer is provided, where the gamma ray scintillation spectrometer is comprised of an inorganic scintillation crystal and a photomultiplier tube optically coupled to the scintillation crystal in a configuration to detect photons emitted by the scintillation crystal in response to the sample. A channel extends through the scintillation crystal where the channel is configured to receive the sample into the crystal and to dispose the sample out of the crystal. Preferably, as described above, the crystal has a length along an axis and the channel has a length along the axis, where the length of the channel along the axis is at least ⅖ the length of the crystal along the axis. The drill cuttings sample is introduced into the channel, and a gamma ray spectrum of the sample is measured with the gamma ray scintillation spectrometer. In a preferred embodiment, the method further comprises providing an NMR relaxometer and measuring an NMR spectrum of the sample with the NMR relaxometer. In a further preferred embodiment, the method further comprises providing a NIGS and measuring a neutron-induced gamma ray spectrum of the sample with the NIGS.

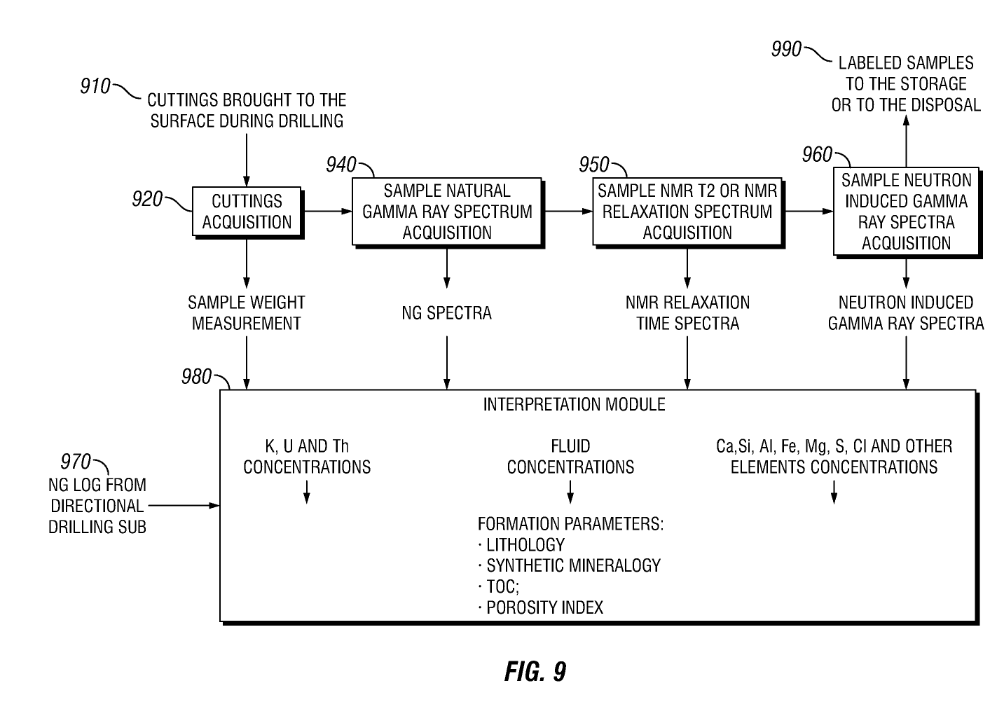

Referring now to FIG. 9, a logging method of the present invention may comprise generating cuttings from a subterranean formation at step 910. The cuttings may be generated using a drill bit during the course of drilling a wellbore. As such, the cuttings may originate from a subterranean formation located at a depth within the well cut by the drill bit. The cuttings may then be swept to the surface with a drilling fluid such as drilling mud that is pumped to the drill bit and circulated back to the surface. The cuttings may take an amount of time to travel to the surface dependent on the drilling depth, the drilling fluid circulation rate, and other downhole factors. Since the cuttings comprise pieces of the formation crushed by the drill bit during drilling operation, properties of these cuttings may be representative of the properties of the formation from which the cuttings originated. As such, if traced back to a wellbore depth, these cuttings may be sampled and analyzed to provide information of the formation properties present at that depth within the wellbore.

At step 920, a cuttings material sample may be formed. In certain embodiments, the cutting sample may be collected and separated from the drilling fluid at the surface using a shaker or any other apparatus capable of separating cuttings from a drilling fluid such as a drilling mud. In certain embodiments, a portion of the cuttings produced at the shaker may be automatically directed mechanically to a cutting sample container. In certain embodiments, a worker may manually collect cuttings at the shaker and place the collected material into a cutting sample container. The cutting sample container should be compatible with the requirements of the instruments (such as the gamma ray scintillation spectrometer, the NMR relaxometer, and the NIGS) to make measurements on the sample. In certain embodiments the cutting sample may be optionally rinsed to remove drilling mud contaminations and/or treated in other ways before being placed into the container. In certain embodiments the void space in the container formed after cutting material has been placed into it may be filled with the hydrocarbon liquid used in the drilling mud. After being placed into the sample container, the cutting sample may be measured to determine its weight.

A controller may control any step of the method, including any spectrometer and/or radiation device (such as a neutron source) and/or moving the cutting sample from one test to another. In certain embodiments, the controller may be connected to a database and be configured to receive control information and/or transmit process information. In certain embodiments, the controller may comprise a display screen and an input panel to allow a worker to input control instructions to the controller.

At step 940 at least one natural gamma ray energy spectrum (NGS) of the drill cutting sample may be measured using a gamma ray scintillation spectrometer. As discussed above, the distinctive feature of the gamma ray scintillation spectrometer is the channel extending through scintillation crystal of the spectrometer which allows samples to be continuously or semi-continuously, either automatically or manually, moved through the scintillation crystal while simultaneously providing high efficiency of the detection of the gamma ray signal emitted by the sample. The natural gamma ray spectra measured by the gamma ray spectrometer may provide information on the concentration of elements within the cuttings that naturally emit gamma ray type radiation while decaying. For example, the gamma ray spectrum measured from the cuttings sample may provide the concentration of potassium, uranium, and/or thorium within the cuttings sample. Each of these elements emit gamma rays at known energy levels, which are unique to a particular element.

At step 950, at least one nuclear magnetic resonance (NMR) relaxation spectrum of the cutting sample may be measured. It can be a transverse relaxation time spectrum (NMR T2 spectrum), a lateral relaxation time spectrum (NMR T1 spectrum), a two dimensional relaxation time spectrum (NMR T1-T2 or other spectra) or any other NMR measurement. In certain embodiments the NMR relaxation time spectra may be acquired using a low magnetic field NMR relaxometer and Car-Purcel-Meiboom-Gill (CPMG) echo train sequence for data acquisition. In certain embodiments, the NMR relaxation time spectrum may provide information about the concentration of the fluid occupying the pores inside the cuttings material sample. The concentration of the fluid residing in cutting material pores is related to the formation porosity and carries the information about the pore system structure. In certain embodiments, the NMR relaxation time spectrum may provide information about the amount of free fluid occupying the voids between pieces of cutting material. The information about the volume of free fluid present in the sample container allows calculation of the volume of the cutting material itself, which together with sample weight and knowledge of the free fluid properties, allows calculation of the bulk density of the cutting material present in sample container.

At step 960, at least one NIGS spectrum of the cutting sample may be measured using a neutron source to expose a sample to a neutron flux and a gamma ray spectrometer to measure the energy spectrum of the gamma rays emitted by the sample material upon interaction with the neutrons. NIGS spectra are any gamma ray spectra emitted by the matter during or after its interaction with fast, slow and thermal neutrons including prompt gamma ray spectra (spectra of gamma rays emitted as a result of the inelastic scattering of fast neutrons by nuclei), capture gamma ray spectra (spectra of gamma rays emitted as a result of the absorption of neutrons by nuclei) and delayed gamma ray spectra (spectra of gamma rays emitted by the nuclei excited as a result of the interaction with neutrons with some time delay after the interaction). Inelastic and capture reactions with the nuclei of different elements may cause the emission of gamma rays with different energies. Gamma rays emitted by nuclei of different elements after the interaction with neutrons (delayed gamma rays) may have different energies. Distinction between energies of gamma rays emitted by nuclei of different elements as a result of different nuclear reactions caused by the interaction with neutrons allows separation of gamma ray signals corresponding to the different elements. The intensity of the gamma ray signal corresponding to particular element is proportional to the concentration of such element in the sample.

To take the NIGS measurement, the neutron source may be activated to generate fast neutrons. In certain embodiments, the neutron source may be activated and/or deactivated by the controller. In certain embodiments the controller may synchronize on/off cycles of neutron source and the operation of data acquisition systems of all nuclear detectors present in the system. In certain embodiments one or more gamma ray detectors may be used to acquire NIGS spectra.

The measured neutron induced gamma ray spectrum may provide information on the concentration of carbon, hydrogen, oxygen, calcium, silicon, aluminum, iron, magnesium, sulfur, chlorine and other elements within the cuttings sample. Each element may emit a gamma ray spectrum having unique energy levels in response to the interaction with neutrons through different reactions. As such, the energy spectrum of gamma rays resulting from interactions of the cuttings material sample with neutrons may provide information on the presence and/or concentration of the various elements above. Particularly the presence of the peaks in the measured spectrum at the energies corresponding to the energies of the gamma rays emitted as a result of the interaction of the nuclei of the specific element with the neutrons indicates the presence of this specific element in the measured sample.

In certain embodiments, the same gamma ray scintillation spectrometer as used to measure the natural gamma ray spectrum at step 940 may also be used to measure the neutron induced gamma ray spectrum. In certain embodiments, a separate gamma ray spectrometer may be used to measure the neutron induced gamma ray spectrum. For example, separate gamma ray spectrometers may be desired for conducting measurements on more than one cutting sample at the same time (e.g., measuring the natural gamma ray spectrum of one cutting sample while the neutron induced gamma ray spectrum is measured on another cutting sample).

It should be noted that, while FIG. 9 is shown and discussed by example with reference to a measurement sequence of NGS, then NMR, followed by NIGS, the method of the present invention is not limited the order of measuring the various spectra of the cutting sample. For example, in certain embodiments, the NMR spectrum may be measured, followed by the NGS measurement, then the NIGS measurement. In certain embodiments, the NGS measurement may be read, followed by the NIGS measurement, then the NMR measurement. In addition, in certain embodiments, additional properties of the cutting sample may be measured and recorded before, after, or in between the measurement steps shown in FIG. 1. In addition, in certain embodiments, other than the NGS measurement, one or more of the measurements may be omitted. For example, in certain embodiments, the cutting sample measurement method may comprise the NGS measurement step followed by the NMR measurement step, excluding the NIGS measurement step.

After measuring the spectra of the cutting sample, the cutting sample may be moved to sample storage or disposed at step 990. For example, the cutting sample may be disposed to a cutting pile along with other cuttings separated from the drilling fluid.

The gamma ray spectrometer, the NMR relaxometer and NIGS and/or other measurement equipment may be connected to an interpretation module as discussed above, and at step 980 the interpretation module may interpret the data provided by the gamma ray scintillating spectrometer, the NMR relaxometer, and/or the NIGS as discussed above with reference to the system.

Each of the measurements taken is bulk sensitive (i.e., information is collected from the entire volume of the cutting sample and not just the surface of the cutting sample). As such, in certain embodiments, additional sample preparation (such as cleaning the sample or drying the sample or homogenizing the sample with pallet preparation) prior to obtaining each measurement may result in limited or minimal improvement of measurement signal quality and may be avoided.

In certain embodiments of the method of the present invention, the drill string used for the well drilling may be equipped with natural gamma ray counter as a part of an MWD/LWD sensor array to allow measurement of the total gamma ray response of the formation during drilling. The MWD/LWD sensor may measure the total gamma ray signal produced by the formation, which is proportional to the integral of the energy spectrum of the natural gamma ray signal. The results of downhole measurement of the total gamma ray signal may be transmitted to the surface during the drilling or can be recorded into the MWD/LWD tool memory. After arriving at the surface, the total gamma ray signal of the formation measured by the downhole gamma ray counter may be transmitted to the interpretation module at step 970. The concentrations of K, U and Th in cutting samples derived from NGS measurements, as measured by the gamma ray scintillation spectrometer, may be transformed into total gamma ray signal of the formation and then compared to the downhole total gamma ray measurement to provide additional location information to map the cutting sample to a formation region in the wellbore and/or to provide an error check when mapping the cutting sample to a formation region of the wellbore. For example, if the total gamma ray signal calculated from K, U and Th concentrations in cutting sample derived from NGS measurements differs from the total gamma ray signal measured downhole, then the formation source of the cutting sample may be misplaced and/or the cutting sample may be compromised or of limited informational value.

The present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. The indefinite articles “a” or “an,” as used in the claims, are defined herein to mean one or more than one of the element that it introduces.

1. A gamma ray scintillation spectrometer, comprising:
an inorganic scintillation crystal, the scintillation crystal having a length along an axis, wherein a channel extends through the scintillation crystal and wherein the channel has a length along the axis that is at least ⅖ the length of the crystal along the axis;
a photomultiplier tube optically coupled to the scintillation crystal in a configuration to detect photons emitted by the scintillation crystal; and
an ionization radiation shield disposed about the crystal, wherein one or more apertures are disposed in the ionization radiation shield aligned with the channel extending through the crystal to provide an opening continuously extending through the ionization radiation shield and the scintillation crystal.

2. The gamma ray scintillation spectrometer of claim 1 wherein the inorganic scintillation crystal is a thallium doped sodium iodide crystal.

3. (canceled)

4. The gamma ray scintillation spectrometer of claim 1, wherein the channel has a length along the axis that is at least ½ the length of the crystal along the axis.

5. A system for sequentially analyzing samples for gamma ray emissions, comprising:
a gamma ray scintillation spectrometer comprising an inorganic scintillation crystal and a photomultiplier tube optically coupled to the scintillation crystal in a configuration to detect photons emitted by the scintillation crystal in response to a sample, wherein a channel extends through the scintillation crystal, the channel being configured to receive a sample into the scintillation crystal and to dispose a sample out of the scintillation crystal; and
a sample feeder configured to feed a sample into the channel in the scintillation crystal.

6. The system for sequentially analyzing samples for gamma ray emissions of claim 5 wherein the scintillation crystal has a length along an axis, the channel has a length along the axis, and the length of the channel along the axis is at least ⅖ the length of the crystal along the axis.

7. (canceled)

8. The system of claim 5, further comprising:
a controller, the controller being operatively coupled to the sample feeder and configured to activate the sample feeder to feed a sample into the channel of the scintillation crystal.

9. The system of claim 5, further comprising a sample holder for holding one or more samples, the sample holder being configured to provide a sample to the sample feeder upon activation.

10. The system of claim 5, further comprising an interpretation module operatively coupled to the gamma ray scintillation spectrometer to receive data from the spectrometer and configured to process data from the spectrometer.

11. The system of claim 5 further comprising a NMR relaxometer configured to receive the sample and measure an NMR spectrum of the sample wherein the NMR relaxometer is directly or indirectly coupled to the gamma ray scintillation spectrometer to receive the sample from the gamma ray scintillation spectrometer or to provide the sample to the gamma ray scintillation spectrometer.

12. The system of claim 5 further comprising a neutron induced gamma ray spectrometer (NIGS) configured to receive the sample and measure a neutron-induced gamma ray spectrum of the sample, the NIGS being directly or indirectly coupled to the gamma ray scintillation spectrometer to receive the sample from the gamma ray scintillation spectrometer or to provide the sample to the gamma ray scintillation spectrometer.

13. A method for analyzing drill cuttings in the process of oil and gas well drilling operations, comprising:
preparing a drill cuttings sample from drill cuttings recovered from an oil and gas well during drilling operations;
providing a gamma ray scintillation spectrometer comprised of an inorganic scintillation crystal and a photomultiplier tube optically coupled to the scintillation crystal in a configuration to detect photons emitted by the scintillation crystal in response to the sample, wherein a channel extends through the scintillation crystal, the channel being configured to receive the sample into the scintillation crystal and to dispose the sample out of the scintillation crystal;
introducing the sample into the channel;
measuring a gamma ray spectrum of the sample with the gamma ray scintillation spectrometer;
providing an NMR relaxometer; and
measuring an NMR spectrum of the sample with the NMR relaxometer.

14. (canceled)

15. The method of claim 13, further comprising:
providing a neutron-induced gamma ray spectrometer (NIGS); and
measuring a neutron-induced gamma ray spectrum of the sample with the NIGS.
